(19) United States
(12) Patent Application Publication
(10) Pub. No.: US 2017/0339703 A1
(43) Pub. Date: Nov. 23, 2017

(54) Device-to-Device (D2D) Interference Coordination Method and Apparatus, Base Station and User Equipment (UE)

(71) Applicant: ZTE Corporation, Shenzhen (CN)

(72) Inventors: Li CHU, Shenzhen (CN); Lin CHEN, Shenzhen (CN)

(21) Appl. No.: 15/518,046

(22) PCT Filed: Jun. 24, 2015
(86) PCT No.: PCT/CN2015/082227

§ 371 Date: Apr. 10, 2017

(30) Foreign Application Priority Data
Oct. 9, 2014 (CN) 201410529901.X

(51) Int. Cl. H04W 72/08; H04W 24/02; H04W 72/12; H04W 72/10; H04W 88/08; H04W 88/02

(52) U.S. Cl. CPC H04W 72/082; H04W 72/12; H04W 72/10; H04W 24/02; H04W 88/02; H04W 88/08

(57) ABSTRACT

Provided is a Device-to-Device (D2D) interference coordination method and apparatus, a base station, and User Equipment (UE). The method includes that: a base station acquires D2D interference state information, wherein the D2D interference state information is used for indicating an interference degree of D2D transmission on a radio resource corresponding to the D2D interference state information (S302); and the base station conducts interference coordination processing according to the D2D interference state information (S304). The disclosure solves the problem of reduced receiving performance of D2D transmission and cellular transmission due to interference or resource conflict resulted from D2D transmission between cells.

### TECHNICAL FIELD

The disclosure relates to the field of communications, and in particular to D2D interference coordination methods and apparatuses, a base station, and UE.

### BACKGROUND

With the development of wireless multimedia services, demands of people for a high data rate and good user experiences are increasing, thereby proposing higher requirements for system capacity and coverage of a traditional cellular network. In another aspect, the popularization of applications such as social networking, data sharing in a short distance and local advertising increases demands of Proximity Services (PS) which renders people to know other interesting people or things nearby and to communicate with the people. A traditional cell-based cellular network is obviously limited on the high data rate and supports for PS. Under this demand background, the D2D technology representing a new development direction of communication technology in the future emerges. Application of the D2D technology can alleviate burdens to the cellular network, reduce power consumption of a battery of UE, increase the data rate, improve the robustness of a network infrastructure, and well meet the requirements on the aforementioned high data rate services and PS.

The D2D technology may work in an authorized frequency band or an unauthorized frequency band, and may allow plenty of UE supporting a D2D function (i.e., D2D UE) to conduct direct discovery and/or direct communication in the presence of the network infrastructure or in the absence of the network infrastructure. There are mainly three D2D application scenarios.

(1) UE1 and UE2 conduct data interaction under the coverage of the cellular network, while user plane data do not pass through the network infrastructure, as Mode 1 in FIG. 1.

(2) Relay transmission is conducted for UE in a weak-coverage/non-coverage area, as Mode 2 in FIG. 1. UE4 with poor signal quality is enabled to communicate with a network via UE3 nearby which is in the coverage of the network. By virtue of this mode, an operator can be assisted in coverage expansion and capacity increase.

(3) Under the condition that an earthquake or an emergency occurs and the cellular network cannot normally work, direct communication between devices is enabled, as shown in mode 3 in FIG. 1. UE5, UE6 and UE7 can conduct one-hop or multi-hop data communication in both the control plane and the user plane without the network infrastructure.

The D2D technology usually includes D2D discovery technology and D2D communication technology.

(1) The D2D discovery technology refers to technology for judging/determining proximity between plenty of D2D UE (e.g., within a range of D2D direct communication) or for judging/determining proximity between first UE and second UE.

(2) The D2D communication technology refers to technology for direct communication of some or all communication data between D2D UEs

Before conducting D2D discovery or D2D communication, D2D UE needs to acquire corresponding radio resources first. There are generally two modes for assigning resources for D2D discovery or D2D communication. A first resource assignment mode is to acquire resources for D2D discovery/communication based on contention-based resource acquisition. A second resource assignment mode is to assign dedicated resources for D2D discovery/communication to UE by a base station. In the first resource assignment mode, a base station or a system usually pre-assigns a D2D resource pool, and a D2D UE participating in D2D discovery/communication monitors the resource pool and acquires D2D transmission resources in a contention manner. This mode may be mainly applied to a D2D UE out of coverage of a cellular network, and may also be applied to D2D UE within the coverage of the cellular network. A D2D contention resource pool configured by the serving cell of the D2D UE may be used for the D2D UE within the coverage of the cellular network. A pre-configured D2D contention resource pool may be used for the D2D UE out of coverage of the cellular network. In the second resource assignment mode, appropriate D2D resources are assigned to the D2D UE. This mode may be only applied to the D2D UE within the coverage of the cellular network.

For D2D discovery and D2D communication, if the D2D UE within the coverage of the cellular network acquires resources in a contention-based resource acquisition mode, a D2D resource pool may be obtained from the base station first, and then the D2D UE may select resources for D2D transmission from the resource pool in a contention manner.

Generally, D2D transmission and cellular transmission share resources, and D2D resources between adjacent cells may be identical or may be different. A scenario in which the D2D transmission and the cellular transmission between the adjacent cells co-exist is as shown in FIG. 2. In this example, UE1 and UE2 are subordinate to a base station eNB1, UE3, UE4 and UE5 are subordinate to a base station eNB2, and the UE is located in an edge area of the corresponding cell. UE1 conducts D2D transmission (signal transmission of D2D discovery or D2D communication) under eNB1, and UE2 and UE3 are conducting corresponding D2D monitoring or receiving the D2D transmission of UE1. UE4 conducts D2D transmission under eNB2, and UE5 is conducting corresponding D2D monitoring or receiving the D2D transmission of UE4. If eNB1 and eNB2 assign the same D2D resources to UE1 and UE4, D2D transmission on UE1 and UE4 may interfere with each other. If UE3 expects to monitor or receive D2D transmission of both UE1 and UE4, normal monitoring or receiving cannot be conducted by UE only having a half-duplex capability due to a conflict of D2D resources between UE1 and UE4.

Under a condition that UE4 conducts cellular transmission, if cellular transmission resources assigned to UE4 by eNB2 are identical to D2D transmission resources assigned to UE1 by eNB1, the cellular transmission of UE4 may interfere with the D2D transmission of UE1.

Generally, uplink resources of cellular communication are commonly adopted for the D2D transmission, so interference between the D2D transmission and the cellular transmission mainly includes interference between the D2D transmission and cellular uplink transmission. If downlink resources of the cellular communication are also adopted for the D2D transmission, interference between the D2D transmission and cellular downlink transmission may also exist.

Interference coordination based on power limitation is conducted via interaction between cells in order to solve the problem of mutual interference of cellular transmission of adjacent cells in the related art. A main method is that:

Overload Indicator (OI) mechanism: an interference overload degree report of each Resource Block (RB) to an adjacent base station in an array list form is provided; each element corresponds to each uplink RB; and values may be high, intermediate and low, which represent different interference degrees.

The inventors discover, in a research process, that targeted information for D2D transmission cannot be provided in the related art and the related art is also unable to distinguish which information is associated with interference between cellular communications and which information is associated with D2D transmission interference. Since load degrees of D2D transmission resources and cellular transmission resources are different, and a policy and priority for D2D transmission are different from those for cellular transmission according to different practical applications; different considerations should be made for corresponding interference processing and scheduling. So, a targeted solution is needed for the problem of interference or resource conflict resulted from the D2D transmission between cells. Failing to provide such targeted solution may greatly affect the effects of D2D transmission and cellular transmission, thus resulting in reduction of receiving performance and severely affecting the user experiences of relevant services.

No effective solution has been proposed yet at present for the problem of reduced receiving performance of D2D transmission and cellular transmission due to interference or resource conflict resulted from D2D transmission between cells in the related art.

### SUMMARY

Some embodiments of the disclosure provide D2D interference coordination methods and apparatuses, a base station and UE, to at least solve the problem of reduced receiving performance of D2D transmission and cellular transmission due to interference or resource conflict resulted from D2D transmission between cells.

According to an aspect of the embodiments of the disclosure, a D2D interference coordination method is provided. In the D2D interference coordination method, a base station acquires D2D interference state information, wherein the D2D interference state information is used for indicating an interference degree of D2D transmission on a radio resource corresponding to the D2D interference state information; and the base station conducts interference coordination processing according to the D2D interference state information.

In an example embodiment, the act that the base station acquires the D2D interference state information may include at least one of the following acts. The base station receives the D2D interference state information sent by UE or an adjacent base station; or the base station generates the D2D interference state information according to an interference condition of radio resources.

In an example embodiment, the D2D interference state information may include at least one of the following information: a group identifier of the D2D transmission, a priority of the D2D transmission, and resource information corresponding to the D2D transmission.

In an example embodiment, the act that interference coordination processing is conducted according to the D2D interference state information may include at least one of the acts. The base station conducts resource assignment or scheduling adjustment for the D2D transmission according to the D2D interference state information; or the base station sends the D2D interference state information to an adjacent base station of the base station; and the base station sends the D2D interference state information to a processing centre.

In an example embodiment, the act that the base station conducts the resource assignment or the scheduling adjustment for the D2D transmission according to the D2D interference state information may include the following acts. The base station determines whether the interference degree of the D2D transmission is higher than a first preset value according to the D2D interference state information; and when the interference degree is higher than the first preset value, on a radio resource of the D2D transmission, the base station preferentially schedules cellular transmission or D2D transmission, wherein the cellular transmission or the D2D transmission is not prone to cause interference to a cell, or schedules no transmission.

In an example embodiment, when the D2D interference state information includes a priority of the D2D transmission, the act that the base station conducts the resource assignment or the scheduling adjustment for the D2D transmission according to the D2D interference state information may include at least one of the following acts. When the priority of the D2D transmission is higher than a second preset value, on the radio resource corresponding to the D2D interference state information, the base station only schedules at least one of cellular transmission or D2D transmission of UE in a cell centre or low-power transmission, or schedules no transmission of any UE; or when the priority of the D2D transmission is not higher than the second preset value, on a radio resource of the D2D transmission, the base station schedules high-priority transmission of a cell centre or edge UE.

In an example embodiment, the act that the base station sends the D2D interference state information to the adjacent base station of the base station may include the following acts. The base station determines at least one of a cell or a base station as a possible interference source according to at least one of the D2D interference state information or D2D resource information of the adjacent base station; and the base station sends the D2D interference state information to at least one of the determined cell or the determined base station.

In an example embodiment, the processing centre may include at least one of: an Operation Administration and Maintenance (OAM), a Mobility Management Entity (MME) or a centralized information centre.

In an example embodiment, an element of a D2D transmission resource, an element of a D2D communication resource, an element of a D2D Scheduling Assignment (SA) resource, an element of a D2D discovery resource, or a Physical Resource Block (PRB) is taken as a unit of the radio resource corresponding to the D2D interference state information.

In an example embodiment, in bitmaps carried in the D2D interference state information, a length of a bitmap corresponding to D2D discovery or D2D communication is identical to the number of discovery resources, SA resources or data PRBs respectively; and the discovery resources, the SA resources and the data PRBs are included by D2D resources.

In an example embodiment, when D2D resources of a cell of the base station are divided into parts used by D2D transmission of cell centre UE or D2D transmission of low-power UE, and parts used by D2D transmission of cell edge UE or D2D transmission of high-power UE, a length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the D2D interference state information and interference state information of an existing cellular resource are indicated uniformly in an Information Element (IE) or indicated individually.

In an example embodiment, Overload Indicator (OI) information is adopted in the D2D interference state information again, or a new IE for indication is adopted.

In an example embodiment, the D2D interference state information is carried in an X2 load information message.

According to another aspect of the embodiments of the disclosure, a D2D interference coordination method is also provided. In the D2D interference coordination method, UE sends D2D interference state information, which is used for indicating an interference degree of D2D transmission on a radio resource corresponding to the D2D interference state information, to a base station, wherein the D2D interference state information is used for instructing the base station to conduct interference coordination processing.

In an example embodiment, the D2D interference state information may include at least one of the following information: a group identifier of the D2D transmission, a priority of the D2D transmission, and resource information corresponding to the D2D transmission.

In an example embodiment, the UE may be triggered to send the D2D interference state information to the base station by one of the following manners: event triggering, periodic reporting, or timer triggering.

In an example embodiment, the event triggering may include at least one of the following acts. The UE detects interference or resource conflict of D2D transmission; or the UE receives a reporting request that the base station instructs the UE to report the D2D interference state information.

In an example embodiment, the periodic reporting may include the following acts. The UE collects an interference degree of D2D corresponding to each resource granularity, and the UE periodically reports an average value of interference degrees of the D2D, wherein a resource unit of the resource granularity includes at least one of: an element of a D2D transmission resource, an element of a D2D communication resource, an element of a D2D discovery resource, an element of an SA resource, a D2D data resource, and a PRB.

In an example embodiment, the act that the UE sends the D2D interference state information to the base station may include that the UE reports the D2D interference state information by one of terminal assistance information, a measurement report, a RRC connection setup, a TAU request flow, and a new message.

According to yet another aspect of the embodiments of the disclosure, a D2D interference coordination apparatus is also provided, which may be applied to a base station and may include: an acquisition component, arranged to acquire D2D interference state information, wherein the D2D interference state information is used for indicating an interference degree of D2D transmission on a radio resource corresponding to the D2D interference state information; and a coordination component, arranged to conduct interference coordination processing according to the D2D interference state information.

In an example embodiment, the coordination component includes at least one of the following elements: a scheduling element, arranged to conduct resource assignment or scheduling adjustment for the D2D transmission according to the D2D interference state information; a first sending element, arranged to send the D2D interference state information to an adjacent base station of the base station; and a second sending element, arranged to send the D2D interference state information to a processing centre.

In an example embodiment, the scheduling element may include a first determination sub-element, arranged to determine whether the interference degree of the D2D transmission is higher than a first preset value according to the D2D interference state information; and a scheduling sub-element, arranged to, when the interference degree is higher than the first preset value, preferentially schedule, on a radio resource of the D2D transmission, cellular transmission or D2D transmission, wherein the cellular transmission or the D2D transmission is not prone to cause interference to a cell, or schedule no transmission.

In an example embodiment, the first sending element may include a second determination sub-element, arranged to determine at least one of a cell or a base station as a possible interference source according to at least one of the D2D interference state information or D2D resource information of the adjacent base station; and a first sending sub-element, arranged to send the D2D interference state information to at least one of the determined cell or the determined base station.

In an example embodiment, the acquisition component includes at least one of a receiving element, arranged to receive the D2D interference state information sent by UE or an adjacent base station; or a generation element, arranged to generate the D2D interference state information according to an interference condition of radio resources.

According to yet another aspect of the embodiments of the disclosure, a D2D interference coordination apparatus is also provided, which may be applied to UE and may include a sending component, arranged to send D2D interference state information, which is used for indicating an interference degree of D2D transmission on a radio resource corresponding to the D2D interference state information, to a base station, wherein the D2D interference state information is used for instructing the base station to conduct interference coordination processing.

According to yet another aspect of the embodiment of the disclosure, a base station is also provided, which may include the D2D interference coordination apparatus applied to a base station.

According to yet another aspect of the embodiments of the disclosure, UE is also provided, which may include the D2D interference coordination apparatus applied to UE.

By means of the embodiment of the disclosure, a base station acquires D2D interference state information, wherein the D2D interference state information is used for indicating an interference degree of D2D transmission on a radio resource corresponding to the D2D interference state information; and the base station conducts interference coordination processing according to the D2D interference state information. The problem of reduced receiving performance of D2D transmission and cellular transmission due to interference or resource conflict resulted from D2D transmission between cells is solved, thereby improving receiving performance and user experiences.

### BRIEF DESCRIPTION OF THE DRAWINGS

The drawings illustrated herein are intended to provide understanding of the disclosure, and form a part of the present application. The schematic embodiments and illustrations of the disclosure are intended to explain the disclosure, and do not form limits to the disclosure. In the drawings:

FIG. 1 is a structural diagram of a D2D transmission network according to the related art;

FIG. 2 is a schematic diagram of a scenario in which D2D transmission and cellular transmission between adjacent cells co-exist according to the related art;

FIG. 3 is a flowchart of a D2D interference coordination method according to an embodiment of the disclosure;

FIG. 4 is a structural diagram of a D2D interference coordination apparatus according to an embodiment of the disclosure;

FIG. 5 is a first exemplary structural diagram of a D2D interference coordination apparatus according to an embodiment of the disclosure;

FIG. 6 is a second exemplary structural diagram of a D2D interference coordination apparatus according to an embodiment of the disclosure;

FIG. 7 is a third exemplary structural diagram of a D2D interference coordination apparatus according to an embodiment of the disclosure; and

FIG. 8 is a fourth exemplary structural diagram 4 of a D2D interference coordination apparatus according to an embodiment of the disclosure.

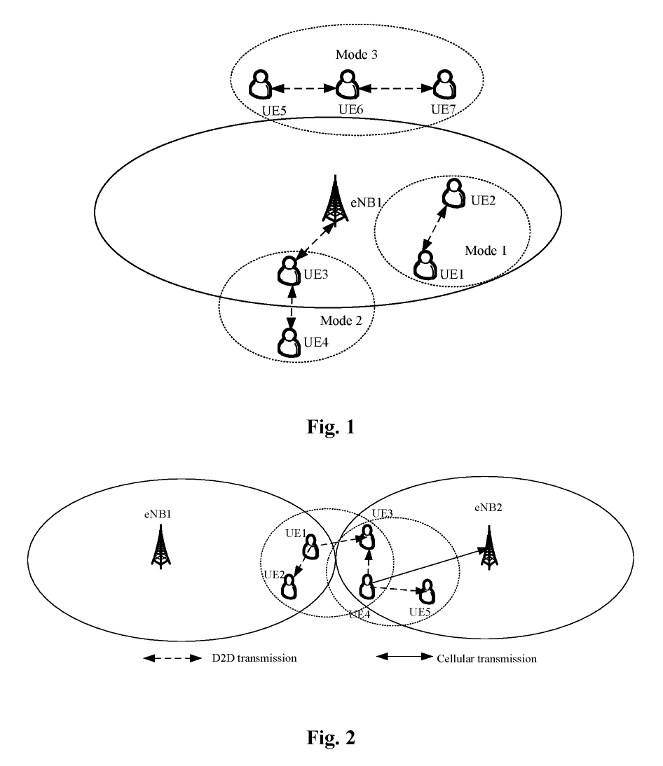

### DETAILED DESCRIPTION OF THE EMBODIMENTS

It may be appreciated that embodiments in the present application and characteristics in the embodiments may be combined under the condition of no conflicts. The disclosure will be described here in below with reference to the drawings and in conjunction with the embodiments in detail.

The acts shown in the flowchart of the drawings may be executed in a computer system including, for example, a set of computer-executable instructions. Moreover, although a logic sequence is shown in the flowchart, the shown or described acts may be executed in a sequence different from the sequence here under certain conditions.

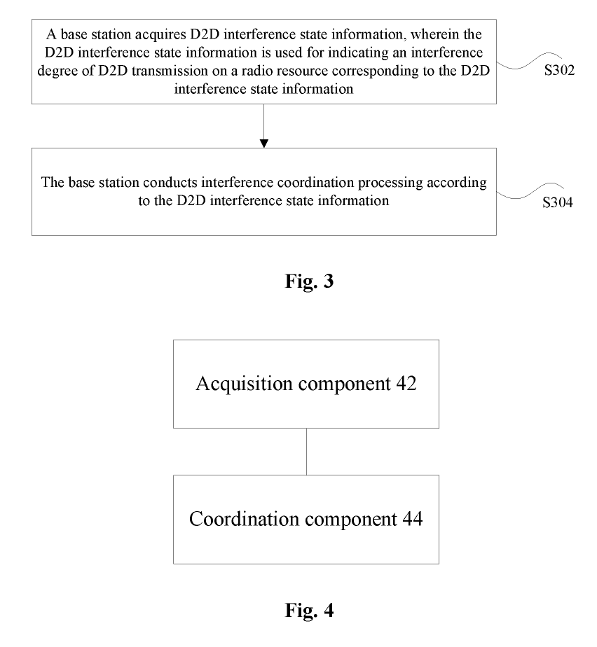

The present embodiment provides a D2D interference coordination method. FIG. 3 is a flowchart of a D2D interference coordination method according to an embodiment of the disclosure. As shown in FIG. 3, the flow includes the following acts.

At act S302, a base station acquires D2D interference state information, wherein the D2D interference state information is used for indicating an interference degree of D2D transmission on a radio resource corresponding to the D2D interference state information.

At act S304, the base station conducts interference coordination processing according to the D2D interference state information.

By means of the aforementioned acts, a base station acquires D2D interference state information, wherein the D2D interference state information is used for indicating an interference degree of D2D transmission on a radio resource corresponding to the D2D interference state information; and the base station conducts interference coordination processing according to the D2D interference state information. The problem of reduced receiving performance of D2D transmission and cellular transmission due to interference or resource conflict resulted from D2D transmission between cells is solved, thereby improving receiving performance and user experiences.

In the above acts, the D2D interference state information acquired by the base station may be generated by the base station according to an interference condition of radio resources, or may be reported by an adjacent base station, or may be reported by UE.

For example, after the base station generates the D2D interference state information or the base station receives the D2D interference state information reported by the UE or shared by other adjacent base stations, the D2D interference state information is sent to the adjacent base station for interference coordination processing.

In an example embodiment, the D2D interference state information indicates the interference degree of the D2D transmission, and may be high, intermediate and low, which represent different interference degrees.

In an example embodiment, the D2D interference state information includes at least one of the following information: a group identifier of the D2D transmission, a priority of the D2D transmission, resource information corresponding to the D2D transmission, etc.

In an example embodiment, after receiving the D2D interference state information, the adjacent base station conducts corresponding interference coordination according to the information. For example, when the D2D interference state information is high, the adjacent base station tries not to schedule cellular transmission or D2D transmission, wherein the cellular transmission or the D2D transmission is prone to cause interference to the D2D transmission on the resource, such as transmission associated with the UE at the edge of a cell or high-power transmission.

In an example embodiment, after receiving the D2D interference state information, the adjacent base station conducts corresponding interference coordination according to the group identifier or priority of the D2D transmission in the information. For example, when the priority of the D2D transmission is high, on the radio resource corresponding to the D2D interference state information, the base station only schedules cellular transmission and/or D2D transmission of the UE in a cell centre or low-power transmission, or does not schedule transmission of any UE. When the priority is low, the base station schedules high-priority transmission of a cell centre or edge UE on the radio resource corresponding to the D2D interference state information.

In an example embodiment, an element of a D2D transmission resource, an element of a D2D communication resource, an element of a D2D SA resource, an element of a D2D discovery resource, or a PRB is taken as a unit of the D2D interference state information provided.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the D2D interference state information and interference state information of an existing cellular resource may be indicated uniformly in an IE or indicated individually. During uniform indication, it is necessary to indicate which information the interference state information is corresponding to the D2D. For example, D2D resource (pool) information is sent to a neighbour cell by interaction between adjacent cells or by an OAM configuration. The neighbour cell may acquire the corresponding D2D interference state information according to the D2D resource (pool) information in combination with uniform interference state information. Alternatively, during individual indication, the base station shall ignore the received interference state information corresponding to D2D resources in the existing cellular interference state information.

In an example embodiment, current OI information is adopted in the D2D interference state information again, or a new IE for indication is adopted. Further, a corresponding D2D identifier may be added for indicating that the information is the D2D interference state information.

In an example embodiment, the D2D interference state information is carried in an X2 load information message.

In an example embodiment, the D2D interference state information is summarized and/or shared to the adjacent base station by being reported via at least one of an OAM, an MME or a centralized information centre.

In an example embodiment, the base station reports the D2D interference state information to the adjacent base station according to the D2D interference state information reported by the UE.

The embodiment of the disclosure also provides a D2D interference coordination method, which is applied to UE and includes the act that the UE sends D2D interference state information, which is used for indicating an interference degree of D2D transmission on a radio resource corresponding to the D2D interference state information, to a base station, wherein the D2D interference state information is used for instructing the base station to conduct interference coordination processing.

In an example embodiment, the D2D interference state information indicates a D2D interference degree report, and may be high, intermediate and low, which represent different interference degrees.

In an example embodiment, the D2D interference state information includes at least one of the following information: a group identifier of the D2D transmission, a priority of the D2D transmission, resource information corresponding to the D2D transmission, etc.

In an example embodiment, an element of a D2D transmission resource, an element of a D2D communication resource, an element of a D2D SA resource, an element of a D2D discovery resource, or a PRB is taken as a unit of the radio resource corresponding to the D2D interference state information. Alternatively, only D2D UE located at the edge of a cell may report an interference condition.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the UE is triggered to report the D2D interference state information to the base station by one of the following manners: event triggering, periodic reporting, and timer triggering.

In an example embodiment, the event triggering includes one of the following acts that (1) the UE detects interference or resource conflict of D2D transmission; alternatively, the UE may detect interference or resource conflict of D2D transmission when monitoring or receiving D2D transmission of other UE, or the UE detects interference or resource conflict of its own D2D transmission, and acquires, for example, the situation by monitoring or receiving feedback of the UE; and (2) the UE receives a reporting request of the base station.

In an example embodiment, the periodic reporting refers to that the UE collects an interference condition of D2D corresponding to each resource granularity, and periodically reports an average value, wherein a resource unit may be an element of a D2D discovery resource, or an element of a SA resource, or a D2D data resource, or a PRB. Alternatively, data resources may be only resources corresponding to D2D communication which is interested by the UE.

In an example embodiment, the UE may report the D2D interference state information by UE terminal assistance information, a measurement report, an RRC connection setup, a TAU request flow or a new message.

In an example embodiment, the base station conducts interference processing according to the D2D interference state information reported by the UE. Alternatively, the interference processing includes one of the following acts.

(1) The base station conducts resource assignment or scheduling adjustment for corresponding D2D transmission according to the D2D interference state information. For example, if the corresponding D2D transmission is transmission within a cell, the D2D interference state information shows that the D2D transmission is highly interfered, so the base station assigns or schedules other resources or resources which are not prone to be interfered for the corresponding D2D transmission.

(2) The base station reports the D2D interference state information to an adjacent base station according to the D2D interference state information reported by the UE. Alternatively, the base station acquires a cell and/or a base station which is a possible interference source according to the D2D interference state information reported by the UE and/or D2D resource (pool) information of the adjacent base station. Alternatively, reporting the D2D interference state information to the adjacent base station refers to that the base station reports the D2D interference state information to the cell and/or the base station which is the possible interference source. Alternatively, the D2D interference state information reported by the UE contains a cell and/or a base station identifier.

In an example embodiment, after receiving the D2D interference state information, the adjacent base station conducts corresponding interference coordination according to the information. For example, when the D2D interference state information is high, the adjacent base station tries not to schedule cellular transmission or D2D transmission, wherein the cellular transmission or the D2D transmission is prone to cause interference to the D2D transmission on the resource, such as transmission associated with the UE at the edge of a cell or high-power transmission.

(3) The base station summarizes and/or shares the D2D interference state information reported by the UE via an OAM or by reporting the D2D interference state information via an MME or a centralized information centre.

In an example embodiment, the base station acquires the D2D interference state information of the adjacent base station via at least one of the OAM, the MME or the centralized information centre.

The present embodiment also provides a D2D interference coordination apparatus, which is applied to a base station. The apparatus is arranged to implement the aforementioned D2D interference coordination methods applied to a base station. FIG. 4 is a structural diagram of a D2D interference coordination apparatus according to an embodiment of the disclosure. As shown in FIG. 4, the apparatus includes an acquisition component 42 and a coordination component 44, wherein the acquisition component 42 is arranged to acquire D2D interference state information, and the D2D interference state information is used for indicating an interference degree of D2D transmission on a radio resource corresponding to the D2D interference state information; and the coordination component 44 is coupled to the acquisition component 42 and is arranged to conduct interference coordination processing according to the D2D interference state information.

It is important to note that the components and the elements involved in the embodiment of the disclosure may be implemented in a software mode, or may be implemented in a hardware mode. The components and the elements described in the present embodiment may be arranged in a processor. For example, it may be described that: a processor includes an acquisition component 42 and a coordination component 44, wherein the names of these components do not form limits to the components under certain conditions. For example, the acquisition component 42 may also be described as a component arranged to acquire D2D interference state information. Moreover, the D2D interference coordination apparatus described in the apparatus embodiment corresponds to the above method embodiment. A specific implementation process thereof has been illustrated in detail in the method embodiment, which will not be elaborated.

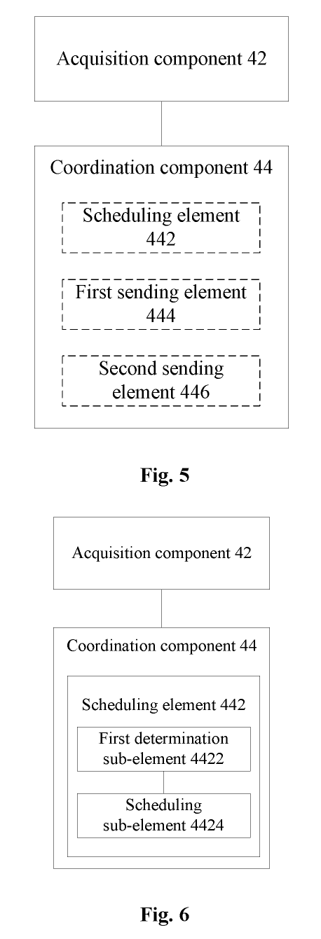

FIG. 5 is a first exemplary structural diagram of a D2D interference coordination apparatus according to an embodiment of the disclosure. Alternatively, the coordination component 44 may include at least one of elements: a scheduling element 442, coupled to the acquisition component 42, and arranged to conduct resource assignment or scheduling adjustment for the D2D transmission according to the D2D interference state information; a first sending element 444, coupled to the acquisition component 42, and arranged to send the D2D interference state information to an adjacent base station of the base station; and a second sending element 446, coupled to the acquisition component 42, and arranged to send the D2D interference state information to a processing centre.

FIG. 6 is a second exemplary structural diagram of a D2D interference coordination apparatus according to an embodiment of the disclosure. Alternatively, the scheduling element 442 may further include a first determination sub-element 4422 and a scheduling sub-element 4424, wherein the first determination sub-element 4422 is arranged to determine whether the interference degree of the D2D transmission is higher than a first preset value according to the D2D interference state information; and the scheduling sub-element 4424 is coupled to the first determination sub-element 4422, and arranged to, when the interference degree is higher than the first preset value, preferentially schedule, on a radio resource of the D2D transmission, cellular transmission or D2D transmission, wherein the cellular transmission or the D2D transmission is not prone to cause interference to a cell, or schedule no transmission.

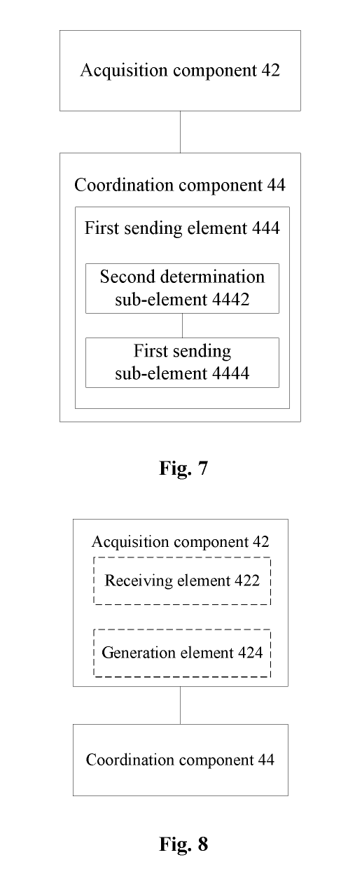

FIG. 7 is a third exemplary structural diagram of a D2D interference coordination apparatus according to an embodiment of the disclosure. Alternatively, the first sending element 444 may further include a second determination sub-element 4442 and a first sending sub-element 4444, wherein the second determination sub-element 4442 is arranged to determine a cell and/or a base station as a possible interference source according to the D2D interference state information and/or D2D resource information of the adjacent base station; and the first sending sub-element 4444 is coupled to the second determination sub-element 4442, and arranged to send the D2D interference state information to the determined cell and/or the determined base station.

FIG. 8 is a fourth exemplary structural diagram 4 of a D2D interference coordination apparatus according to an embodiment of the disclosure. Alternatively, the acquisition component 42 may further include at least one of a receiving element 422 or a generation element 424, wherein the receiving element 422 is arranged to receive the D2D interference state information sent by UE or an adjacent base station; and the generation element 424 is arranged to generate the D2D interference state information according to an interference condition of radio resources.

The present embodiment also provides a base station, which includes the D2D interference coordination apparatus applied to a base station.

The present embodiment also provides another D2D interference coordination apparatus, applied to UE. The apparatus includes a sending component 52, wherein the sending component 52 is arranged to send D2D interference state information which is used for indicating an interference degree of D2D transmission on a radio resource corresponding to the D2D interference state information, to a base station, and the D2D interference state information is used for instructing the base station to conduct interference coordination processing.

The present embodiment also provides UE, which includes the D2D interference coordination apparatus applied to UE.

In order to make the technical solutions and the implementation methods of the disclosure clearer, the implementation process will be described herein in detail in conjunction with example embodiments.

### Method Embodiment 1

The present embodiment describes a method that a base station provides D2D interference state information for an adjacent base station. The method includes the following acts.

At act 1, the base station provides D2D interference state information for the adjacent base station. The D2D interference state information indicates an interference degree of D2D transmission, and may be high, intermediate and low, which represent different interference degrees.

In an example embodiment, the D2D interference state information includes at least one of the following information: a group identifier of the D2D transmission, a priority of the D2D transmission, resource information corresponding to the D2D transmission, etc.

At act 2, after receiving the D2D interference state information, the adjacent base station conducts corresponding interference coordination according to the information. For example, when the D2D interference state information is high, the adjacent base station tries not to schedule cellular transmission or D2D transmission, wherein the cellular transmission or the D2D transmission is prone to cause interference to the D2D transmission on the resource, such as transmission associated with the UE at the edge of a cell or high-power transmission. Alternatively, after receiving the D2D interference state information, the adjacent base station conducts corresponding interference coordination according to the group identifier or priority of the D2D transmission in the information. For example, when the priority of the D2D transmission is high, on the radio resource corresponding to the D2D interference state information, the base station only schedules cellular transmission and/or D2D transmission of the UE in a cell centre or low-power transmission, or does not schedule transmission of any UE. When the priority is low, the base station schedules high-priority transmission of a cell centre or edge UE on the radio resource corresponding to the D2D interference state information.

In an example embodiment, an element of a D2D transmission resource, an element of a D2D communication resource, an element of a D2D SA resource, an element of a D2D discovery resource, or a PRB is taken as a unit of the D2D interference state information provided.

In an example embodiment, an element of a D2D transmission resource, an element of a D2D communication resource, an element of a D2D SA resource, an element of a D2D discovery resource, or a PRB is taken as a unit of interference sensitivity information of D2D resources.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, for example, by means of an eNB configuration update message or a load information message, or may be configured by an OAM.

In an example embodiment, the D2D interference state information and interference state information of an existing cellular resource may be indicated uniformly in an IE or indicated individually. During uniform indication, it is necessary to indicate which information the interference state information is corresponding to the D2D. For example, D2D resource (pool) information is sent to a neighbour cell by interaction between adjacent cells or by an OAM configuration. The neighbour cell may acquire the corresponding D2D interference state information according to the D2D resource (pool) information in combination with uniform interference state information. Alternatively, during individual indication, the base station shall ignore the received interference state information corresponding to D2D resources in the existing cellular interference state information.

In an example embodiment, a current OI IE is adopted in the D2D interference state information again, or a new IE for indication is adopted. Further, a corresponding D2D identifier may be added for indicating that the information is the D2D interference state information.

In an example embodiment, the D2D interference state information is carried in an X2 load information message.

In an example embodiment, the D2D interference state information is summarized and/or shared to the adjacent base station by being reported via at least one of an OAM, an MME or a centralized information centre.

In an example embodiment, the base station reports the D2D interference state information to the adjacent base station according to the D2D interference state information reported by the UE.

### Method Embodiment 2

The present embodiment describes a method that UE reports D2D interference state information to a base station. The method includes the following acts.

At act 1, the UE reports D2D interference state information to a base station. The D2D interference state information indicates a D2D interference degree report, and may be high, intermediate and low, which represent different interference degrees. At act 2, the base station conducts interference processing according to the D2D interference state information reported by the UE. Alternatively, the interference processing includes one of the following acts.

(1) The base station conducts resource assignment or scheduling adjustment for corresponding D2D transmission according to the D2D interference state information. For example, if the corresponding D2D transmission is transmission within a cell, the D2D interference state information shows that the D2D transmission is highly interfered, so the base station assigns or schedules other resources or resources which are not prone to be interfered for the corresponding D2D transmission.

(2) The base station reports the D2D interference state information to an adjacent base station according to the D2D interference state information reported by the UE. Alternatively, the base station acquires a cell and/or a base station which is a possible interference source according to the D2D interference state information reported by the UE and/or D2D resource (pool) information of the adjacent base station. Alternatively, reporting the D2D interference state information to the adjacent base station refers to that the base station reports the D2D interference state information to the cell and/or the base station which is the possible interference source.

(3) The base station summarizes and/or shares the D2D interference state information reported by the UE via an OAM or by reporting the D2D interference state information via an MME or a centralized information centre.

In an example embodiment, the D2D interference state information includes at least one of the following information: a group identifier of the D2D transmission, a priority of the D2D transmission, resource information corresponding to the D2D transmission, etc.

In an example embodiment, an element of a D2D transmission resource, an element of a D2D communication resource, an element of a D2D SA resource, an element of a D2D discovery resource, or a PRB is taken as a unit of the radio resource corresponding to the D2D interference state information. Alternatively, only D2D UE located at the edge of a cell may report an interference condition.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the UE is triggered to report the D2D interference state information to the base station by one of the following manners: event triggering, periodic reporting, and timer triggering.

In an example embodiment, the event triggering includes one of the following acts that (1) the UE detects interference or resource conflict of D2D transmission; alternatively, the UE may detect interference or resource conflict of D2D transmission when monitoring or receiving D2D transmission of other UE, or the UE detects interference or resource conflict of its own D2D transmission, and acquires, for example, the situation by monitoring or receiving feedback of the UE; and (2) the UE receives a reporting request of the base station.

In an example embodiment, the periodic reporting refers to that the UE collects an interference condition of D2D corresponding to each resource granularity, and periodically reports an average value, wherein a resource unit may be an element of a D2D discovery resource, or an element of a SA resource, or a D2D data resource, or a PRB. Alternatively, data resources may be only resources corresponding to D2D communication which is interested by the UE.

In an example embodiment, the UE may report the D2D interference state information by UE terminal assistance information, a measurement report, an RRC connection setup, a TAU request flow or a new message.

In an example embodiment, the base station acquires the D2D interference state information of the adjacent base station via at least one of the OAM, the MME or the centralized information centre.

### Method Embodiment 3

The present embodiment describes a method that UE reports D2D interference state information to a base station and after the base station receives the information, the base station, the base station provides the D2D interference state information for an adjacent base station thereby realizing to conduct interference coordination. The method includes the following acts.

At step 1, UE reports D2D interference state information to a base station. The D2D interference state information indicates a D2D interference degree report, and may be high, intermediate and low, which represent different interference degrees.

At act 2, the base station reports the D2D interference state information to an adjacent base station after receiving the information. Alternatively, the base station acquires a cell and/or a base station which is possible interference source according to the D2D interference state information reported by the UE and/or D2D resource (pool) information of the adjacent base station. Alternatively, reporting the D2D interference state information to the adjacent base station refers to that the base station reports the D2D interference state information to the cell and/or the base station which is the possible interference source.

In an example embodiment, the base station may summarize and/or share the D2D interference state information reported by the UE to the adjacent base station via an OAM or by reporting the D2D interference state information via an MME or a centralized information centre.

At act 3, after receiving the D2D interference state information, the adjacent base station conducts corresponding interference coordination according to the information. For example, when the D2D interference state information is high, the adjacent base station tries not to schedule cellular transmission or D2D transmission, wherein the cellular transmission or the D2D transmission is prone to cause interference to the D2D transmission on the resource, such as transmission associated with the UE at the edge of a cell or high-power transmission.

In an example embodiment, the D2D interference state information includes at least one of the following information: a group identifier of the D2D transmission, a priority of the D2D transmission, resource information corresponding to the D2D transmission, etc.

In an example embodiment, an element of a D2D transmission resource, an element of a D2D communication resource, an element of a D2D SA resource, an element of a D2D discovery resource, or a PRB is taken as a unit of the radio resource corresponding to the D2D interference state information. Alternatively, only D2D UE located at the edge of a cell may report an interference condition.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the UE is triggered to report the D2D interference state information to the base station by one of the following manners: event triggering, periodic reporting, and timer triggering.

In an example embodiment, the event triggering includes one of the following acts that (1) the UE detects interference or resource conflict of D2D transmission; alternatively, the UE may detect interference or resource conflict of D2D transmission when monitoring or receiving D2D transmission of other UE, or the UE detects interference or resource conflict of its own D2D transmission, and acquires, for example, the situation by monitoring or receiving feedback of the UE; and (2) the UE receives a reporting request of the base station.

In an example embodiment, the periodic reporting refers to that the UE collects an interference condition of D2D corresponding to each resource granularity, and periodically reports an average value, wherein a resource unit may be an element of a D2D discovery resource, or an element of a SA resource, or a D2D data resource, or a PRB. Alternatively, data resources may be only resources corresponding to D2D communication which is interested by the UE.

In an example embodiment, the UE may report the D2D interference state information by UE terminal assistance information, a measurement report, an RRC connection setup, a TAU request flow or a new message.

In an example embodiment, the base station acquires the D2D interference state information of the adjacent base station via the OAM, the MME and/or the centralized information centre.

### Method Embodiment 4

The present embodiment describes a method that UE reports D2D interference state information to a base station and after the base station receives the information, the base station conducts interference coordination. The method includes the following acts.

At act 1, UE reports D2D interference state information to a base station. The D2D interference state information indicates a D2D interference degree report, and may be high, intermediate and low, which represent different interference degrees.

At act 2, after receiving the information, the base station conducts resource assignment or scheduling adjustment for corresponding D2D transmission according to the D2D interference state information. For example, if the corresponding D2D transmission is transmission within a cell, the D2D interference state information shows that the D2D transmission is highly interfered, so the base station assigns or schedules other resources or resources which are not prone to be interfered for the corresponding D2D transmission.

In an example embodiment, the D2D interference state information includes at least one of the following information: a group identifier of the D2D transmission, a priority of the D2D transmission, resource information corresponding to the D2D transmission, etc.

In an example embodiment, an element of a D2D transmission resource, an element of a D2D communication resource, an element of a D2D SA resource, an element of a D2D discovery resource, or a PRB is taken as a unit of interference sensitivity information of D2D resources. Alternatively, only D2D UE located at the edge of a cell may report an interference condition.

In an example embodiment, different bitmaps may be further distinguished for D2D discovery or D2D communication, a length of a bitmap corresponding to the D2D discovery or D2D communication is identical to the number of discovery resources, SA resources or data PRBs respectively; and the discovery resources, the SA resources and the data PRBs are comprised by D2D resources.

In an example embodiment, D2D resources of a cell are divided into parts used by D2D transmission of cell centre UE or D2D transmission of low-power UE, and parts used by D2D transmission of cell edge UE or D2D transmission of high-power UE. Alternatively, the D2D interference state information only indicates D2D interference state information of the parts used by the D2D transmission of the cell edge UE or the D2D transmission of the high-power UE. That is, the length of the bitmap carried in the D2D interference state information is identical to the number of resources for the D2D transmission of the cell edge UE or the D2D transmission of the high-power UE.

In an example embodiment, block information of the D2D resources is configured by means of interaction between adjacent cells, or configured by an OAM.

In an example embodiment, the UE is triggered to report the D2D interference state information to the base station by one of the following manners: event triggering, periodic reporting, and timer triggering.

In an example embodiment, the event triggering includes one of the following acts that (1) the UE detects interference or resource conflict of D2D transmission; alternatively, the UE may detect interference or resource conflict of D2D transmission when monitoring or receiving D2D transmission of other UE, or the UE detects interference or resource conflict of its own D2D transmission, and acquires, for example, the situation by monitoring or receiving feedback of the UE; and (2) the UE receives a reporting request of the base station.

In an example embodiment, the periodic reporting refers to that the UE collects an interference condition of D2D corresponding to each resource granularity, and periodically reports an average value, wherein a resource unit may be an element of a D2D discovery resource, or an element of a SA resource, or a D2D data resource, or a PRB. Alternatively, data resources may be only resources corresponding to D2D communication which is interested by the UE.

In an example embodiment, the UE may report the D2D interference state information by UE terminal assistance information, a measurement report, an RRC connection setup, a TAU request flow or a new message.

In conclusion, the abovementioned embodiments, example embodiments and implementation manners of the disclosure solve the problem of interference or resource conflict of D2D transmission between adjacent cells in D2D discovery or D2D communication and the problem of interference or resource conflict between D2D transmission and cellular transmission. Compared with the related art, the method and system of the disclosure can provide a solution for pointedly solving the interference or conflict according to a policy and a priority during practical application of D2D transmission, thereby improving the quality of D2D services and user experiences.

Industrial applicability: by means of the abovementioned embodiments, the disclosure solves the problem of reduced receiving performance of D2D transmission and cellular transmission due to interference or resource conflict resulted from D2D transmission between cells, thereby improving receiving performance.

Obviously, those skilled in the art shall understand that the above-mentioned components or steps of the disclosure can be realized by using general purpose calculating device, can be integrated in one calculating device or distributed on a network which consists of a plurality of calculating devices. Alternatively, the components or the steps of the disclosure can be realized by using the executable program code of the calculating device. Consequently, they can be stored in the storing device and executed by the calculating device, and under some circumstances, the shown or described steps can be executed in different orders, or they are made into integrated circuit component respectively, or a plurality of components or steps thereof are made into one integrated circuit component. In this way, the disclosure is not restricted to any particular hardware and software combination.

The descriptions above are only the example embodiment of the disclosure, which are not used to restrict the disclosure. For those skilled in the art, the disclosure may have various changes and variations. Any amendments, equivalent substitutions, improvements, etc. within the principle of the disclosure are all included in the scope of the protection of the disclosure.

1. A Device-to-Device (D2D) interference coordination method, comprising:
acquiring, by a base station, D2D interference state information, wherein the D2D interference state information is used for indicating an interference degree of D2D transmission on a radio resource corresponding to the D2D interference state information; and
conducting, by the base station, interference coordination processing according to the D2D interference state information.

2. The method as claimed in claim 1, wherein acquiring, by the base station, the D2D interference state information comprises at least one of:
receiving, by the base station, the D2D interference state information sent by User Equipment (UE) or an adjacent base station; or
generating, by the base station, the D2D interference state information according to an interference condition of radio resources.

3. The method as claimed in claim 1, wherein the D2D interference state information comprises at least one of:
a group identifier of the D2D transmission, a priority of the D2D transmission, or resource information corresponding to the D2D transmission.

4. The method as claimed in claim 1, wherein conducting the interference coordination processing according to the D2D interference state information comprises at least one of:
conducting, by the base station, resource assignment or scheduling adjustment for the D2D transmission according to the D2D interference state information;
sending, by the base station, the D2D interference state information to an adjacent base station of the base station; or
sending, by the base station, the D2D interference state information to a processing centre.

5. The method as claimed in claim 4, wherein conducting, by the base station, the resource assignment or the scheduling adjustment for the D2D transmission according to the D2D interference state information comprises:
determining, by the base station, whether the interference degree of the D2D transmission is higher than a first preset value according to the D2D interference state information; and
when the interference degree is higher than the first preset value, on a radio resource of the D2D transmission, preferentially scheduling, by the base station, cellular transmission or D2D transmission, wherein the cellular transmission or the D2D transmission is not prone to cause interference to a cell, or scheduling, by the base station, no transmission.

6. The method as claimed in claim 4, wherein when the D2D interference state information comprises a priority of the D2D transmission, conducting, by the base station, the resource assignment or the scheduling adjustment for the D2D transmission according to the D2D interference state information comprises at least one of:
when the priority of the D2D transmission is higher than a second preset value, on the radio resource corresponding to the D2D interference state information, only scheduling, by the base station, at least one of cellular transmission or D2D transmission of UE in a cell centre or low-power transmission, or scheduling, by the base station, no transmission of any UE; or
when the priority of the D2D transmission is not higher than the second preset value, on the radio resource corresponding to the D2D interference state information, scheduling, by the base station, high-priority transmission of a cell centre or edge UE.

7. The method as claimed in claim 4, wherein sending, by the base station, the D2D interference state information to the adjacent base station of the base station comprises:
determining, by the base station, at least one of a cell or a base station as a possible interference source according to at least one of the D2D interference state information or D2D resource information of the adjacent base station; and
sending, by the base station, the D2D interference state information to at least one of the determined cell or the determined base station.

8. The method as claimed in claim 4, wherein the processing centre comprises at least one of:
an Operation Administration and Maintenance (OAM), a Mobility Management Entity (MME) or a centralized information centre.

9. The method as claimed in claim 1, wherein an element of a D2D transmission resource, an element of a D2D communication resource, an element of a D2D Scheduling Assignment (SA) resource, an element of a D2D discovery resource, or a Physical Resource Block (PRB) is taken as a unit of the radio resource corresponding to the D2D interference state information.

10. The method as claimed in claim 9, wherein in bitmaps carried in the D2D interference state information, a length of a bitmap corresponding to D2D discovery or D2D communication is identical to the number of discovery resources, SA resources or data PRBs respectively; and the discovery resources, the SA resources and the data PRBs are comprised by D2D resources.

11. The method as claimed in claim 9, wherein when D2D resources of a cell of the base station are divided into parts used by D2D transmission of cell centre UE or D2D transmission of low-power UE, and parts used by D2D transmission of cell edge UE or D2D transmission of high-power UE, a length of the bitmap carried in the D2D interference state information is identical to the number of resources for the D2D transmission of the cell edge UE or the D2D transmission of the high-power UE.

12. The method as claimed in claim 11, wherein block information of the D2D resources is configured by means of interaction between adjacent cells, or configured by an Operation Administration and Maintenance (OAM).

13. The method as claimed in claim 1, wherein the D2D interference state information and interference state information of an existing cellular resource are indicated uniformly in an Information Element (IE) or indicated individually;
Overload Indicator (OI) information is adopted in the D2D interference state information again, or a new Information Element (IE) for indication is adopted; or
the D2D interference state information is carried in an X2 load information message.

14. (canceled)

15. (canceled)

16. A Device-to-Device (D2D) interference coordination method, comprising:
sending, by User Equipment (UE), D2D interference state information, which is used for indicating an interference degree of D2D transmission on a radio resource corresponding to the D2D interference state information, to a base station, wherein the D2D interference state information is used for instructing the base station to conduct interference coordination processing.

17. The method as claimed in claim 16, wherein the D2D interference state information comprises at least one of:
a group identifier of the D2D transmission, a priority of the D2D transmission, or resource information corresponding to the D2D transmission.

18. The method as claimed in claim 16, wherein the UE is triggered to send the D2D interference state information to the base station by one of the following manners:
event triggering, periodic reporting, or timer triggering.

19. The method as claimed in claim 18, wherein the event triggering comprises at least one of:
detecting, by the UE, interference or resource conflict of D2D transmission; or
receiving, by the UE, a reporting request that the base station instructs the UE to report the D2D interference state information.

20. The method as claimed in claim 18, wherein the periodic reporting comprises:
collecting, by the UE, an interference degree of D2D corresponding to each resource granularity, and periodically reporting, by the UE, an average value of interference degrees of the D2D, wherein a resource unit of the resource granularity comprises at least one of: an element of a D2D transmission resource, an element of a D2D communication resource, an element of a D2D discovery resource, an element of a Scheduling Assignment (SA) resource, a D2D data resource, and a Physical Resource Block (PRB).

21. The method as claimed in claim 16, wherein sending, by the UE, the D2D interference state information to the base station comprises:
reporting, by the UE, the D2D interference state information by one of terminal assistance information, a measurement report, a Radio Resource Control (RRC) connection setup, a Tracking Area Update (TAU) request flow, and a new message.

22. A Device-to-Device (D2D) interference coordination apparatus, applied to a base station, comprising:
an acquisition component, arranged to acquire D2D interference state information, wherein the D2D interference state information is used for indicating an interference degree of D2D transmission on a radio resource corresponding to the D2D interference state information; and
a coordination component, arranged to conduct interference coordination processing according to the D2D interference state information.

23. (canceled)

24. (canceled)

25. (canceled)

26. (canceled)

27. A Device-to-Device (D2D) interference coordination apparatus, applied to User Equipment (UE), comprising:
a sending component, arranged to send D2D interference state information, which is used for indicating an interference degree of D2D transmission on a radio resource corresponding to the D2D interference state information, to a base station, wherein the D2D interference state information is used for instructing the base station to conduct interference coordination processing.

28. A base station, comprising: the D2D interference coordination apparatus as claimed in claim 22.

29. User Equipment (UE), comprising: the D2D interference coordination apparatus as claimed in claim 27.
